(19) United States
(12) Patent Application Publication
(10) Pub. No.: US 2006/0132225 A1
(43) Pub. Date: Jun. 22, 2006

(54) Standard voltage generation circuit

(76) Inventors: Junichi Naka, Neyagawa-shi (JP); Michiko Tokumaru, Hirakata-shi (JP); Yoichi Okamoto, Hirakata-shi (JP); Koji Oka, Ibaraki-shi (JP)

Correspondence Address: WENDEROTH, LIND & PONACK, L.L.P., 2033 K STREET N. W., SUITE 800, WASHINGTON, DC, 20006-1021, US

(21) Appl. No.: 11/317,173

(22) Filed: Dec. 27, 2005

Related U.S. Application Data
(62) Division of application No. 10/784,929, filed on Feb. 25, 2004.

(30) Foreign Application Priority Data
Feb. 25, 2003 (JP) 2003-046651

(51) Int. Cl. G05F 1/10

(52) U.S. Cl. 327/538

(57) ABSTRACT

A standard voltage generation circuit is provided with a function of automatically stopping charging when a standard voltage reaches a stable voltage point by rapidly charging a standard voltage stabilization capacitor during transition from a standby state to a normal operation state. The standard voltage generation circuit is also provided with a function of precharging an output terminal of the circuit to a voltage close to the stable voltage by a potential division effect of the capacitor during transition from the standby state to the normal operation state. Thereby, it is possible to prevent an increase in the amount of time that is required until the standard voltage reaches the stable voltage when the state of an analog circuit included in the standard voltage generation circuit changes from its off state to its on state.

This application is a divisional of U.S. application Ser. No. 10/784,929, filed Feb. 25, 2004.

### FIELD OF THE INVENTION

The present invention relates to a standard voltage generation circuit and, more particularly, to a standard voltage generation circuit which is capable of rapid startup.

### BACKGROUND OF THE INVENTION

In a system LSI on which a digital circuit block and an analog circuit block having relatively large power consumption coexist, reduction in power consumption of the analog circuit block has become a major challenge. This demand is especially strong for portable equipment, and the power to a mounted analog circuit block is turned on and off at appropriate timings according to the usage state so as to reduce power consumption. For example, in a communication system including a transmitter and a receiver, the receiver is turned off during transmission while the transmitter is turned off during reception.

FIG. 19 is a block diagram illustrating a conventional standard voltage generation circuit as an analog circuit which is included in such a system, which turns another analog circuit on and off. The conventional standard voltage generation circuit is disclosed in “The Standard Text, Design of OP Amplifier Circuit” written by Michio Okamoto, CQ Publication Co. Ltd., first edition on Sep. 10, 1990. In FIG. 19, reference numeral 1 denotes a standard voltage generation circuit body for generating a standard voltage Vr, reference numeral 2 denotes an analog circuit that is operated by using the standard voltage generation circuit body 1, and reference numeral 3 denotes a standard voltage stabilization capacitor for stabilizing the standard voltage Vr. Further, Pdn denotes a standby signal which turns off the standard voltage generation circuit body 1 and the analog circuit 2 when the standby signal is “High”, and turns on these circuits when the standby signal is “Low”. Furthermore, Vr denotes an output voltage of the standard voltage generation circuit body 1, and the output (standard) voltage Vr is stabilized by the standard voltage stabilization capacitor 3.

FIG. 20 is a schematic diagram illustrating a change in the output voltage Vr when the standby signal is changed between “High” and “Low”. In FIG. 20, tr denotes a recovery time that is required until the output voltage Vr attains a stable standard voltage Vr0.

In this way, in the conventional standard voltage generation circuit, the period tr for charging the standard voltage stabilization capacitor 3 is required until the standard voltage generation circuit changes from the standby state to the normal operation state, and this period tr causes a delay in recovery.

In the above-mentioned conventional standard voltage generation circuit, it takes a long time for the standard voltage Vr to reach the stable standard voltage Vr0, and therefore, there are cases where a recovery time which is requested by the system cannot be satisfied. Especially in a circuit where the standard voltage stabilization capacitor 3 is large, the time that is required for charging the capacitor 3 is long, and as a result, the recovery time tr is considerably long, so that the analog circuit cannot be turned on and off at appropriate timings.

### SUMMARY OF THE INVENTION

The present invention is made to solve the above-mentioned problems. Accordingly, an object of the present invention is to provide a standard voltage generation circuit which can rapidly stabilize a standard voltage.

Other objects and advantages of the present invention will become apparent from the following detailed description. The detailed description and specific embodiments described herein are provided only for illustration since various additions and modifications within the scope of the present invention will be apparent to those of skill in the art from the detailed description.

According to a first aspect of the present invention, there is provided a standard voltage generation circuit comprising: a standard voltage generation circuit body for generating a standard voltage; a standard voltage stabilization capacitor for stabilizing the standard voltage; and a standard voltage rapid stabilizer for rapidly stabilizing the standard voltage. Therefore, it is possible to rapidly increase or decrease the standard voltage by rapidly charging or discharging the standard voltage stabilization capacitor when the standard voltage generation circuit changes from the standby state to the normal operation state, thereby resulting in a reduction in the amount of time that is required until the standard voltage reaches the stable standard voltage.

According to a second aspect of the present invention, in accordance with the standard voltage generation circuit of the first aspect, the standard voltage rapid stabilizer comprises a rapid charging/discharging current source which performs rapid charging or rapid discharging to/from the standard voltage stabilization capacitor. Therefore, it is possible to rapidly increase or decrease the standard voltage by rapidly charging or discharging the standard voltage stabilization capacitor when the standard voltage generation circuit changes from the standby state to the normal operation state.

According to a third aspect of the present invention, in accordance with the standard voltage generation circuit of the second aspect, the rapid charging/discharging current source comprises a bias current source for outputting a predetermined current; and a current mirror circuit including a first conductivity type first transistor having a source connected to a first voltage, a drain connected to the bias current source and a gate and the drain being short-circuited, and a first conductivity type second transistor having a source connected to the first voltage, a drain connected to the standard voltage stabilization capacitor and a gate connected to the gate of the first conductivity type first transistor. Therefore, it is possible to rapidly increase the standard voltage by rapidly charging the standard voltage stabilization capacitor when the standard voltage generation circuit changes from the standby state to the normal operation state.

According to a fourth aspect of the present invention, in accordance with the standard voltage generation circuit of the second aspect, the rapid charging/discharging current source comprises a bias current source for outputting a predetermined current; and a current mirror circuit including a second conductivity type first transistor having a source connected to a second voltage, a drain connected to the bias current source and a gate and the drain being short-circuited, and a second conductivity type second transistor having a source connected to the second voltage, a drain connected to the standard voltage stabilization capacitor, and a gate connected to the gate of the second conductivity type first transistor. Therefore, it is possible to rapidly decrease the standard voltage by rapidly discharging the standard voltage stabilization capacitor when the standard voltage generation circuit changes from the standby state to the normal operation state.

According to a fifth aspect of the present invention, the standard voltage generation circuit according to the first aspect further comprises a sub standard voltage generation circuit for generating a sub standard voltage; a voltage detection comparator for comparing the standard voltage generated by the standard voltage generation circuit body with the sub standard voltage generated by the sub standard voltage generation circuit, and outputting the result of comparison; and a stop circuit for stopping the operation of the standard voltage rapid stabilizer for charging or discharging the standard voltage stabilization capacitor, according to the result of comparison by the voltage detection comparator. Therefore, it is possible to prevent an increase in the amount of time that is required until the standard voltage reaches the stable voltage by rapidly charging the standard voltage stabilization capacitor up to the sub standard voltage or rapidly discharging the standard voltage down to a predetermined voltage and, thereafter, stopping the charging/discharging operation, when the standard voltage generation circuit changes from the standby state to the normal operation state.

According to a sixth aspect of the present invention, in accordance with the standard voltage generation circuit of the fifth aspect, the sub standard voltage generation circuit is not provided with a capacitor for stabilizing the sub standard voltage. Therefore, it is possible to generate a sub standard voltage that increases rapidly.

According to a seventh aspect of the present invention, in accordance with the standard voltage generation circuit of the fifth aspect, the sub standard voltage generation circuit comprises a resistance type potential divider. Therefore, it is possible to generate a sub standard voltage that increases rapidly, with a relatively simple construction.

According to an eighth aspect of the present invention, there is provided a standard voltage generation circuit comprising: a standard voltage generation circuit body for generating a standard voltage, and outputting the standard voltage from a first terminal; a first capacitor element having both ends being connected to a first constant voltage and charged during a standby period, and one of the both ends being connected to the first constant voltage while the other end is connected to a third voltage that is higher than the standard voltage during a normal operation period; and a second capacitor element having both ends being connected to a second constant voltage and charged during the standby period, and one of the both ends being connected to the second constant voltage while the other end is connected to a fourth voltage that is lower than the standard voltage during the normal operation period. The capacitance ratio between the first capacitor element and the second capacitor element is a value that makes a voltage at a common node converge to a voltage in the vicinity of the standard voltage. The common node is a point where the one end of the first capacitor element that is charged to the third voltage and the one end of the second capacitor element that is charged to the fourth voltage are connected. At the transition from the standby period to the normal operation period, the first terminal outputting the standard voltage and the common node are changed from the non-conducting states to the conducting states. Therefore, it is possible to rapidly increase the standard voltage to the stable voltage point by pre-charging the output terminal of the circuit to a voltage which is close to the standard voltage by using the potential division effect of the capacitors, when the standard voltage generation circuit changes from the standby state to the normal operation state.

According to a ninth aspect of the present invention, there is provided a standard voltage generation circuit comprising: a standard voltage generation circuit body for generating a standard voltage, and outputting the standard voltage from a first terminal; a first conductivity type eighth transistor having a source, a drain, and a gate, the source being connected to a first constant voltage that is different from the standard voltage by at least a threshold voltage of the transistor, during a standby period, the gate and the drain being electrically connected to each other, and a difference in voltages between the gate and the source being biased to a predetermined voltage that is higher than the threshold voltage, and during a normal operation period, the source and the drain being electrically connected to each other; a first conductivity type seventh transistor having a source connected to the source of the first conductivity type eighth transistor, and a drain connected to the drain of the first conductivity type eighth transistor, the seventh transistor electrically disconnecting the source and the drain of the first conductivity type eighth transistor during the standby period, and electrically connecting them during the normal operation period; a first conductivity type sixth transistor having a source connected to the drain of the first conductivity type eighth transistor, and a drain connected to the gate of the first conductivity type eighth transistor, the sixth transistor electrically connecting the gate and the drain of the first conductivity type eighth transistor during the standby period, and electrically disconnecting them during the normal operation period; a second conductivity type third transistor having a source connected to a second constant voltage, and a drain connected to the gate of the first conductivity type eighth transistor, the third transistor biasing a difference in voltages between the gate and the source of the first conductivity type eighth transistor to a predetermined voltage larger than the threshold voltage of the first conductivity type eighth transistor during the standby period, and being turned off during the normal operation period; a first conductivity type ninth transistor having a source connected to the first constant voltage and a drain connected to the first terminal, the ninth transistor being turned on during the standby period, and turned off during the normal operation period; and a first conductivity type fifth transistor having a source connected to the first terminal, and a drain connected to the gate of the first conductivity type eighth transistor, the fifth transistor being brought into conduction during at least a period until a difference in voltages between the gate of the first conductivity type eighth transistor and the first terminal attains a predetermined value, at the time of transition from the standby period to the normal operation period. In this ninth aspect, the eighth transistor is set in a diode connection state while the gate of the transistor is biased to a voltage which is close to the stable voltage during standby, and the drain is connected to the source while the gate is connected to the output terminal of the standard voltage generation circuit during normal operation, whereby the output terminal of the circuit is pre-charged to a voltage which is close to the stable voltage, and the standard voltage can be rapidly brought to the stable voltage point.

According to a tenth aspect of the present invention, in accordance with the standard voltage generation circuit of the ninth aspect, the standard voltage generation circuit body comprises a constant current source for outputting a predetermined current; and a first conductivity type transistor having a source connected to the first constant voltage, a drain connected to the constant current source, and a gate and the drain being short-circuited. The gate of the first conductivity type transistor outputs the standard voltage. Therefore, it is possible to prevent an increase in the time required until the standard voltage reaches the stable voltage.

According to an eleventh aspect of the present invention, there is provided a standard voltage generation circuit comprising: a standard voltage generation circuit body for generating a standard voltage, and outputting the standard voltage from a first terminal; a reference standard voltage generation circuit for generating a predetermined range of a reference voltage including the standard voltage; a switch that is turned off during a standby period, and turned on during a normal operation period; a capacitor element having one end connected to the first terminal through the switch, and the other end connected to a fifth fixed voltage; a voltage detection circuit for comparing the reference voltage with a voltage at the one end of the capacitor element, and outputting the result of the comparison; and a control circuit for controlling charging/discharging of the capacitor element according to the result of the detection by the voltage detection circuit so that the voltage at the one end of the capacitor element approaches the standard voltage. In this eleventh aspect, the capacitor element is maintained at a voltage which is close to the stable voltage during standby, and the output terminal of this circuit is connected to the capacitor element to precharge the circuit to a voltage which is close to the stable voltage during normal operation, whereby the standard voltage can be rapidly brought to the stable voltage point.

According to a twelfth aspect of the present invention, in accordance with the standard voltage generation circuit of the eleventh aspect, the reference standard voltage generation circuit generates two reference voltages including a reference voltage that is higher than the standard voltage, and a reference voltage that is lower than the standard voltage. The control circuit comprises: a first conductivity type transistor having a drain connected to the one end of the capacitor element, a source connected to a power supply voltage, and a gate connected to the output of the voltage detection circuit; and a second conductivity type transistor having a drain connected to the one end of the capacitor element, a source connected to a ground voltage, and a gate connected to the output of the voltage detector circuit. The voltage detection circuit comprises two comparators for outputting the result of detection so as to turn on the second conductivity type transistor and turn off the first conductivity type transistor when the voltage at the one end of the capacitor element becomes equal to or higher than the reference voltage that is higher than the standard voltage, and outputting the result of detection so as to turn on the first conductivity type transistor and turn off the second conductivity type transistor when the voltage at the one end of the capacitor element becomes equal to or lower than the standard voltage. In this twelfth aspect, the capacitor element is maintained at a voltage which is close to the stable voltage during standby, and the output terminal of this circuit is connected to the capacitor element to precharge the circuit to a voltage which is close to the stable voltage during normal operation, whereby the standard voltage can be rapidly brought to the stable voltage point.

According to a thirteenth aspect of the present invention, in accordance with the standard voltage generation circuit of the eleventh aspect, the reference standard voltage generation circuit generates a reference voltage in the vicinity of the standard voltage. The control circuit comprises: a first conductivity type transistor having a drain connected to the one end of the capacitor element, a source connected to the power supply voltage, and a gate connected to the output of the voltage detector circuit; and a second conductivity type transistor having a drain connected to the one end of the capacitor element, a source connected to the ground voltage, and a gate connected to the output of the voltage detection circuit. The voltage detection circuit comprises a hysteresis comparator that compares the voltage at the one end of the capacitor element with the reference voltage, outputs “High” when the voltage at the one end of the capacitor element is equal to or higher than the reference voltage, and outputs “Low” when the voltage is equal to or lower than the reference voltage. In this thirteenth aspect, the capacitor element is maintained at a voltage which is close to the stable voltage during standby, and the output terminal of this circuit is connected to the capacitor element to precharge the circuit to a voltage close to the stable voltage during normal operation, whereby the standard voltage can be rapidly brought to the stable voltage point.

According to a fourteenth aspect of the present invention, there is provided a standard voltage generation circuit comprising: a standard voltage generation circuit body for generating a standard voltage, and outputting the standard voltage from a first terminal; a reference standard voltage generation circuit for generating two reference voltages including a reference voltage that is higher than the standard voltage, and a reference voltage that is lower than the standard voltage; a switch that is turned off during a standby period, and turned on during a normal operation period; a capacitor element having one end connected to the first terminal through the switch, and the other end connected to a fifth fixed voltage; and a voltage detection control circuit comprising a first conductivity type transistor having a source connected to the one end of the capacitor element, a gate connected to the reference voltage that is lower than the standard voltage, and a drain connected to a ground voltage, and a second conductivity type transistor having a source connected to the one end of the capacitor element, a gate connected to the reference voltage that is higher than the standard voltage and a drain connected to a power supply voltage. In this fourteenth aspect, the capacitor element is maintained at a voltage which is close to the stable voltage during standby, and the output terminal of this circuit is connected to the capacitor element to precharge the circuit to a voltage which is close to the stable voltage during normal operation, whereby the standard voltage can be rapidly brought to the stable voltage point.

According to a fifteenth aspect of the present invention, in accordance with the standard voltage generation circuit of the fourteenth aspect, the reference standard voltage generation circuit comprises: a sub standard voltage generation circuit for outputting the reference voltage in the vicinity of the standard voltage from a first output terminal; a bias circuit comprising a first conductivity type fourteenth transistor having a source connected to the power supply voltage and a gate and a drain being short-circuited, and a second conductivity type eighth transistor having a source connected to the ground voltage, a drain connected to the drain of the first conductivity type fourteenth transistor, and a gate and the drain being short-circuited; a first conductivity type thirteenth transistor having a source connected to the power supply voltage, and a gate connected to the gate of the first conductivity type fourteenth transistor of the bias circuit; a second conductivity type seventh transistor having a source connected to the ground voltage, and a gate connected to the gate of the second conductivity type eighth transistor of the bias circuit; a second conductivity type sixth transistor having a drain connected to the drain of the first conductivity type thirteenth transistor, a source connected to the first output terminal and biased to a voltage in the vicinity of the standard voltage, and a gate and the drain being short-circuited; and a first conductivity type twelfth transistor having a drain connected to the drain of the second conductivity type seventh transistor, a source connected to the first output terminal and biased to a voltage in the vicinity of the standard voltage. A predetermined current is passed through the second conductivity type sixth transistor and the first conductivity type twelfth transistor to generate a reference voltage that is higher than the standard voltage at the gate of the second conductivity type sixth transistor, and a reference voltage that is lower than the standard voltage at the gate of the first conductivity type twelfth transistor. Therefore, it is possible to generate stable reference voltages against variations in processing.

### BRIEF DESCRIPTION OF THE DRAWINGS

FIG. 1 is a block diagram illustrating a standard voltage generation circuit according to a first embodiment of the present invention.

FIG. 2 is a diagram illustrating voltage changes in the standard voltage generation circuit according to the first embodiment and the conventional standard voltage generation circuit.

FIG. 3 is a block diagram illustrating a standard voltage generation circuit according to a second embodiment of the present invention.

FIG. 4 is a diagram illustrating voltage changes in the standard voltage generation circuit according to the second embodiment and the conventional standard voltage generation circuit.

FIG. 5 is a block diagram illustrating a standard voltage generation circuit according to a third embodiment of the present invention.

FIG. 6 is a diagram illustrating voltage changes in the standard voltage generation circuit according to the third embodiment, a sub standard voltage generation circuit, and the conventional standard voltage generation circuit.

FIG. 7 is a block diagram illustrating a sub standard voltage generation circuit utilizing resistance type pressure division, according to the third embodiment.

FIG. 8 is a block diagram illustrating a standard voltage generation circuit according to a fourth embodiment of the present invention.

FIG. 9 is a diagram illustrating the operation state of a standard voltage generation circuit body, the timings of ON/OFF state transitions of switches SW1 to SW4, and voltage changes at certain points in the standard voltage generation circuit, according to the fourth embodiment.

FIG. 10 is a block diagram illustrating a standard voltage generation circuit according to a fifth embodiment of the present invention.

FIG. 11 is a diagram illustrating the operation state of the standard voltage generation circuit body, the timings of ON/OFF state transitions of switches SW1 to SW4, and voltage changes in the standard voltage generation circuit, according to the fifth embodiment.

FIG. 12 is a block diagram illustrating a standard voltage generation circuit according to a sixth embodiment of the present invention.

FIG. 13 is a diagram illustrating the operation state of the standard voltage generation circuit body according to the sixth embodiment, the timing of ON/OFF state transition of a switch SW, and voltage changes in the standard voltage generation circuit according to the sixth embodiment and in the conventional circuit.

FIG. 14 is a block diagram illustrating a reference standard voltage generation circuit utilizing resistance type pressure division, according to the sixth embodiment.

FIG. 15 is a block diagram illustrating another example of a standard voltage generation circuit according to the sixth embodiment.

FIG. 16 is a block diagram illustrating a standard voltage generation circuit according to a seventh embodiment of the present invention.

FIG. 17 is a diagram illustrating the operation state of the standard voltage generation circuit body according to the seventh embodiment, the timing of ON/OFF state transition of a switch SW, and voltage changes in the standard voltage generation circuit according to the seventh embodiment and in the conventional circuit.

FIG. 18 is a block diagram illustrating an example of a reference standard voltage generation circuit included in the standard voltage generation circuit according to the seventh embodiment.

FIG. 19 is a block diagram illustrating an analog circuit including the conventional standard voltage generation circuit.

FIG. 20 is a diagram illustrating voltage changes in the analog circuit including the conventional standard voltage generation circuit.

### DETAILED DESCRIPTION OF THE PREFERRED EMBODIMENTS

### First Embodiment

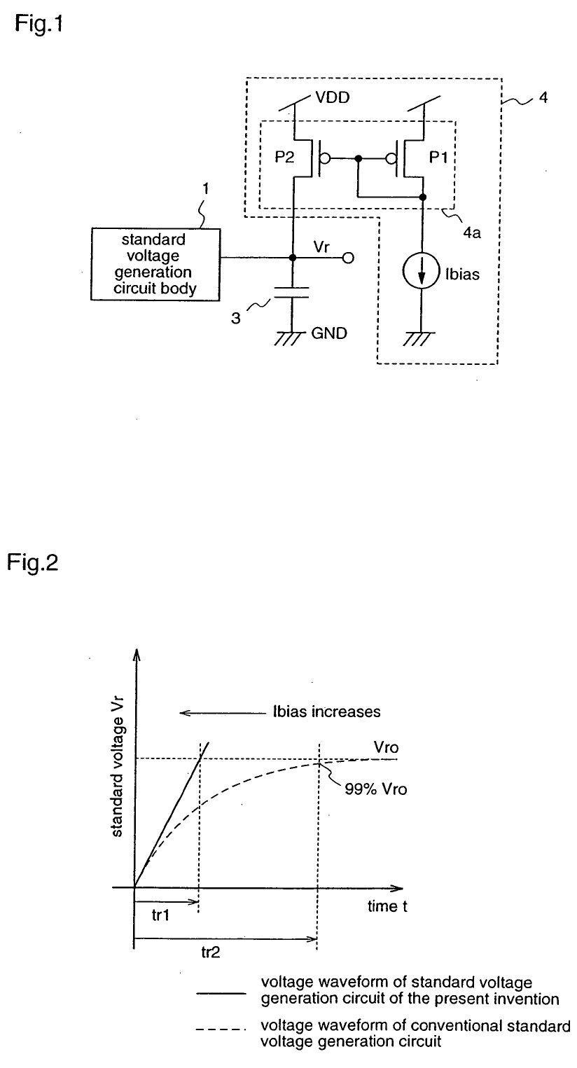

FIG. 1 is a block diagram illustrating the construction of a standard voltage generation circuit according to a first embodiment of the present invention.

In FIG. 1, the standard voltage generation circuit comprises a standard voltage generation circuit body 1 for generating a standard voltage Vr; a standard voltage stabilization capacitor 3 for stabilizing the standard voltage Vr; and a standard voltage rapid stabilizer 4. The standard voltage rapid stabilizer 4 comprises P type transistors P1 and P2 and a bias current Ibias, and serves as a rapid charge/discharge current source for rapidly stabilizing the standard voltage Vr.

An end of the bias current source Ibias is connected to a standard voltage (GND). The other end of the bias current source Ibias is connected to a drain terminal and a gate terminal of the current mirror P type transistor P1 and to a gate terminal of the current mirror P type transistor P2. A source terminal of the transistor P1 and a source terminal of the transistor P2 are connected to a standard voltage (VDD) as a first voltage, and the first conductivity type first transistor P1 and the first conductivity type second transistor P2 constitute a current mirror circuit 4a.

Further, an output terminal of the standard voltage generation circuit body 1 is connected to a drain terminal of the transistor P2 and to an end of the standard voltage stabilization capacitor 3, and the other end of the standard voltage stabilization capacitor 3 is connected to the standard voltage (GND).

The operation of the standard voltage generation circuit according to the first embodiment of the present invention will now be described.

When the bias current is pulled to the standard voltage (GND) by the current source Ibias, the transistor P1 is brought into conduction, whereby the current Ibias flows in the transistor P1. Further, the current mirror structure brings the transistor P2 into conduction, whereby the current Ibias flows in the transistor P2. This current Ibias makes a charging current Ibias flow in the standard voltage stabilization capacitor 3. Thereby, the voltage at the output terminal of the standard voltage generation circuit body 1, i.e., the output voltage Vr of the standard voltage generation circuit, is linearly increased.

FIG. 2 is a diagram illustrating a voltage waveform of the standard voltage generation circuit according to the first embodiment, and a voltage waveform of the conventional standard voltage generation circuit. As shown in FIG. 2, in the conventional standard voltage generation circuit, a recovery time that is required until the voltage is stabilized is
tr2=−RC·ln (1−Vrf/Vro)

Assuming that a target stable voltage Vrf is 99% of the Vro,
tr2=−RC·ln (1−0.99)

On the other hand, a recovery time that is required until the standard voltage reaches the stable voltage in the construction of the present invention is
tr1=CVro/Ibis
and the recovery time can be reduced by increasing the current Ibias. In the above formulae, C is the capacitance of the standard voltage stabilization capacitor 3, R is the resistance component included in the path wherein the current flows into the standard voltage stabilization capacitor 3 to charge the capacitor 3, and Vro is the stable standard voltage.

As described above, in the standard voltage generation circuit according to the first embodiment, the standard voltage generation circuit body 1 is provided with the standard voltage stabilization capacitor 3, and the standard voltage rapid stabilizer 4 comprising the P type transistors. Therefore, when the standard voltage generation circuit changes from the standby state to the normal operation state, the standard voltage stabilization capacitor 3 is rapidly charged by the standard voltage rapid stabilizer 4 while in the conventional structure the standard voltage stabilization capacitor 3 is charged by only the current from the standard voltage generation circuit body 1, whereby the voltage Vr at the output terminal of the standard voltage generation circuit body 1 can be rapidly increased.

While an ordinary current mirror circuit is used in the first embodiment, a cascode type current mirror can be used with the same effects as mentioned above.

Further, it is possible to change the voltage Vr by inserting a diode-connected transistor between the transistor P2 and the standard voltage stabilization capacitor 3 (not shown).

### Second Embodiment

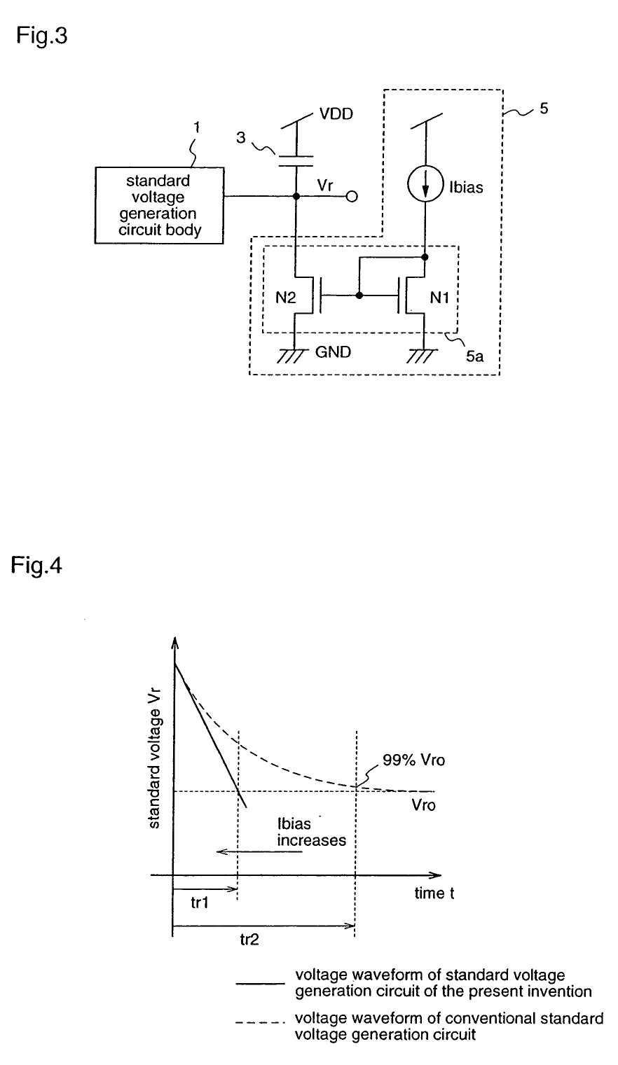

FIG. 3 is a block diagram illustrating a standard voltage generation circuit according to a second embodiment of the present invention.

In FIG. 3, the standard voltage generation circuit comprises a standard voltage generation circuit body 1 for generating a standard voltage Vr; a standard voltage stabilization capacitor 3 for stabilizing the standard voltage Vr; and a standard voltage rapid stabilizer 5. the standard voltage rapid stabilizer 5 comprises N type transistors N1 and N2 and a bias current source Ibias, and serves as a rapid charge/discharge current source for rapidly stabilizing the standard voltage Vr.

An end of the bias current source Ibias is connected to a standard voltage (VDD), and the other end of the bias current source Ibias is connected to a drain terminal and a gate terminal of the current mirror N type transistor N1 and to a gate terminal of the current mirror N type transistor N2. A source terminal of the transistor N1 and a source terminal of the transistor N2 are connected to a standard voltage (GND) as a second voltage, and the second conductivity type first transistor N1 and the second conductivity type second transistor N2 constitute a current mirror circuit 5a.

Further, an output terminal of the standard voltage generation circuit body 1 is connected to a drain terminal of the transistor N2 and to an end of the standard voltage stabilization capacitor 3, while the other end of the standard voltage stabilization capacitor 3 is connected to the standard voltage (VDD).

The operation of the standard voltage generation circuit according to the second embodiment constituted as described above will now be described.

The standard voltage stabilization capacitor 3 is charged up to a high voltage by the standard voltage VDD. Then, the bias current is sent into the standard voltage (VDD) by the current source Ibias, whereby a current Ibias flows into the transistor N1. Further, the current Ibias also flows into the transistor N2 by the current mirror structure. Thereby, a charging current Ibias flows into the standard voltage stabilization capacitor 3. At the same time, the transistor N2 is brought into conduction, and thereby the voltage Vr at the output terminal of the standard voltage generation circuit body 1 drops linearly, and simultaneously, the standard voltage stabilization capacitor 3 is discharged.

FIG. 4 is a diagram illustrating a voltage waveform of the standard voltage generation circuit according to the second embodiment, and a voltage waveform of the conventional standard voltage generation circuit. As shown in FIG. 4, in the conventional standard voltage generation circuit, a recovery time that is required until the voltage is stabilized is expressed by
tr2=RC·ln(1−(Vs−Vrf)/(Vs−Vro)
wherein Vs is the initial voltage.

Assuming that a target stable voltage Vrf is 99% of the (Vs−Vro),
tr2=−RC·ln(1−0.99)

On the other hand, a recovery time that is required until the standard voltage reaches the stable voltage Vro in the construction of the present invention is expressed by
tr1=C(Vs−Vro)/Ibias
and the recovery time can be reduced by increasing the current Ibias. In the above formulae, C is the capacitance of the standard voltage stabilization capacitor 3, and R is the resistance component included in the path wherein the current flows into the standard voltage stabilization capacitor 3 to charge the capacitor 3.

As described above, in the standard voltage generation circuit according to the second embodiment, the standard voltage generation circuit body 1 is provided with the standard voltage stabilization capacitor 3 and the standard voltage rapid stabilizer 5 comprising the N type transistors. Therefore, when the standard voltage generation circuit changes from the standby state to the normal operation state, the standard voltage stabilization capacitor 3 that has been charged is rapidly discharged by the standard voltage rapid stabilizer 5, whereby the voltage Vr at the output terminal of the standard voltage generation circuit body 1 can be rapidly dropped.

While an ordinary current mirror circuit is used in this second embodiment, a cascode type current mirror can be used with the same effects as mentioned above.

Further, it is possible to change the voltage Vr by a diode-connected transistor (not shown) that is inserted between the transistor N2 and the standard voltage stabilization capacitor 3.

### Third Embodiment

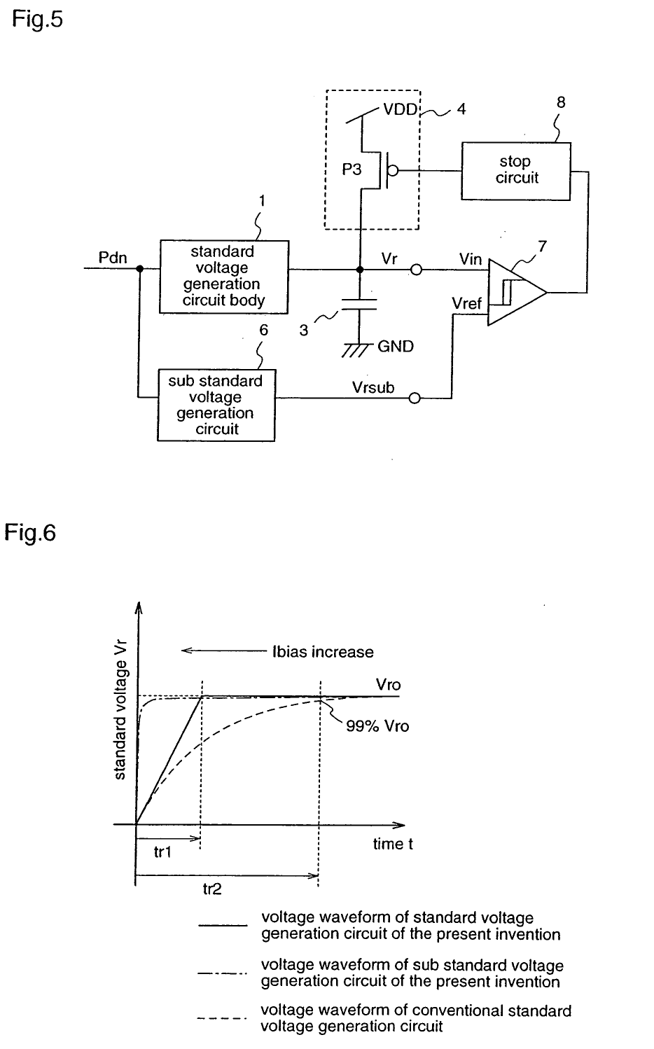

FIG. 5 is a block diagram illustrating the construction of a standard voltage generation circuit according to a third embodiment of the present invention.

In FIG. 5, the standard voltage generation circuit is provided with a standard voltage generation circuit body 1 for generating a standard voltage Vr; a standard voltage stabilization capacitor 3 for stabilizing the standard voltage Vr; a standard voltage rapid stabilizer (P type transistor) 4 for rapidly stabilizing the standard voltage Vr; a sub standard voltage generation circuit 6 for generating a sub standard voltage Vrsub; a voltage detection comparator 7 for detecting and comparing the standard voltage Vr and the sub standard voltage Vrsub, and outputting the result of comparison; and a stop circuit 8 for stopping the charging operation to the capacitor 3, of the standard voltage rapid stabilizer 4, according to the result of comparison.

A source terminal of the transistor P3 is connected to a standard voltage (VDD), a gate terminal of the transistor P3 is connected to the output of the stop circuit 8, and the output of the voltage detection comparator 7 is connected to the input of the stop circuit 8. The output of the standard voltage generation circuit body 1 is connected to a drain terminal of the transistor P3, an end of the standard voltage stabilization capacitor 3, and an input terminal Vin of the voltage detection comparator 7. The output of the sub standard voltage generation circuit 6 is connected to a comparison voltage terminal Vref of the voltage detection comparator 7, and a standby signal Pdn is connected to the standard voltage generation circuit body 1 and the sub standard voltage generation circuit 6. Further, the other end of the standard voltage stabilization capacitor 3 is connected to a standard voltage (GND).

The operation of the standard voltage generation circuit according to the third embodiment constituted as described above will now be described.

FIG. 6 is a diagram illustrating a voltage waveform of the standard voltage generation circuit according to the third embodiment, a voltage waveform of the sub standard voltage generation circuit 6, and a voltage waveform of the conventional standard voltage generation circuit.

Since the sub standard voltage generation circuit 6 has no stabilization capacity, the output voltage Vrsub of the sub standard voltage generation circuit 6 rapidly approaches the stable standard voltage Vro as compared with the output voltage Vr of the standard voltage generation circuit. On the other hand, the output voltage Vr of the standard voltage generation circuit linearly increases because the standard voltage generation circuit is charged by the standard voltage rapid stabilizer 4.

When the output voltage Vr of the standard voltage generation circuit becomes equal to the output voltage Vrsub of the sub standard voltage generation circuit 6, the result of the comparison of the voltage detector comparator 7 changes. The stop circuit 8 stops the charging operation of the standard voltage rapid stabilizer 4 according to the output of the voltage detector comparator 7.

As described above, the standard voltage generation circuit according to the third embodiment is provided with the standard voltage generation circuit body 1 for generating a standard voltage, the sub standard voltage generation circuit 6 for rapidly generating a sub standard voltage, the standard voltage rapid stabilizer 4 for rapidly charging the standard voltage stabilization capacitor 3, the voltage detector comparator 7 for detecting and comparing the sub standard voltage and the standard voltage to output the result of comparison, and the stop circuit 8 for stopping the charging operation of the standard voltage rapid stabilizer 4 when it is detected that the standard voltage is equal to the sub voltage. Therefore, the voltage Vr at the output terminal of the standard voltage generation circuit body 1 can be rapidly increased, and further, an arbitrary standard voltage can be obtained rapidly and accurately.

While a P type transistor current source is employed in this third embodiment, an N type transistor may be employed as in the second embodiment with the same effects as described above.

Further, while an ordinary current mirror is used in this third embodiment, a cascode type current mirror can be used with the same effects as mentioned above.

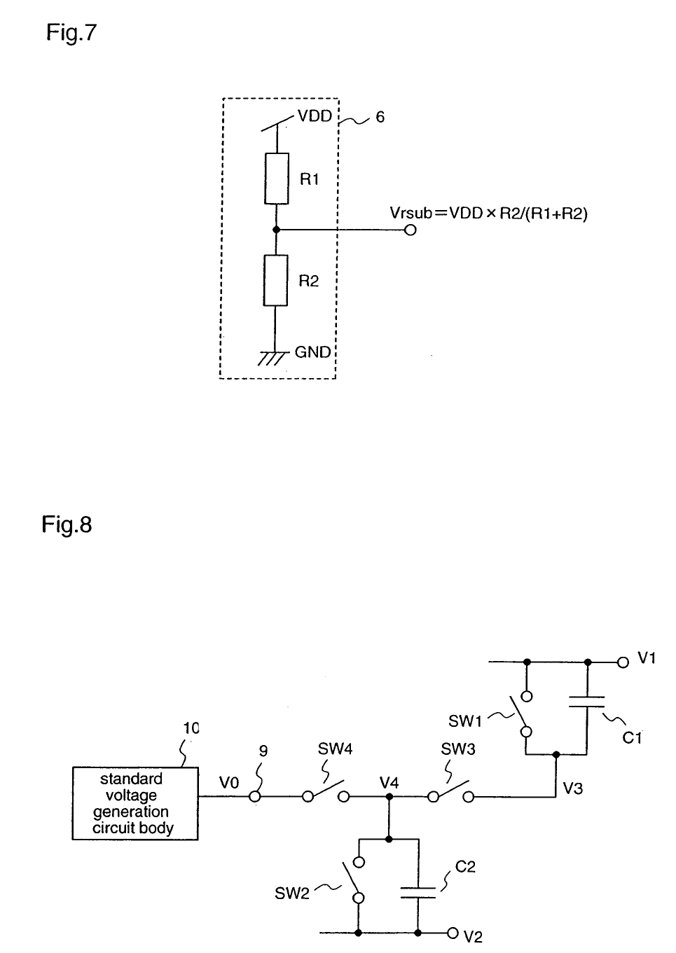

Further, the sub standard voltage generation circuit 6 may have the same constitution as the standard voltage generation circuit body 1, or the sub standard voltage generation circuit 6 may be constituted by a frequency divider using resistors R1 and R2 as shown in FIG. 7. That is, a standard voltage generation circuit which is capable of rapidly generating a voltage that approaches the stable standard voltage Vro can achieve the same effects as described above.

Furthermore, when the output voltage Vr of the standard voltage generation circuit attains the stable standard voltage Vro to stop the standard voltage rapid stabilizer 4, the sub standard voltage generation circuit 6 may be stopped to reduce power consumption.

### Fourth Embodiment

FIG. 8 is a block diagram illustrating the construction of a standard voltage generation circuit according to a fourth embodiment of the present invention.

In FIG. 8, the standard voltage generation circuit is provided with a standard voltage generation circuit body 10 for generating a standard voltage V0 from an output terminal 9; a first capacitor element C1 having an end connected to a power supply voltage V1 as a first constant voltage, and the other end connected to the power supply voltage V1 through a switch SW1; a second capacitor element C2 having an end connected to a ground voltage V2 as a second constant voltage, and the other end connected to the ground voltage V2 through a switch SW2; a switch SW3 having both ends connected to a node of the switch SW1 and the first capacitor element C1 and to a node of the switch SW2 and the second capacitor element C2, respectively; and a switch SW4 having both ends connected to an end of the switch SW3 and to the output terminal 9, respectively. The output terminal 9 is a standard voltage output terminal of the standard voltage generation circuit.

Hereinafter, the operation of the standard voltage generation circuit according to the fourth embodiment constituted as described above will be described.

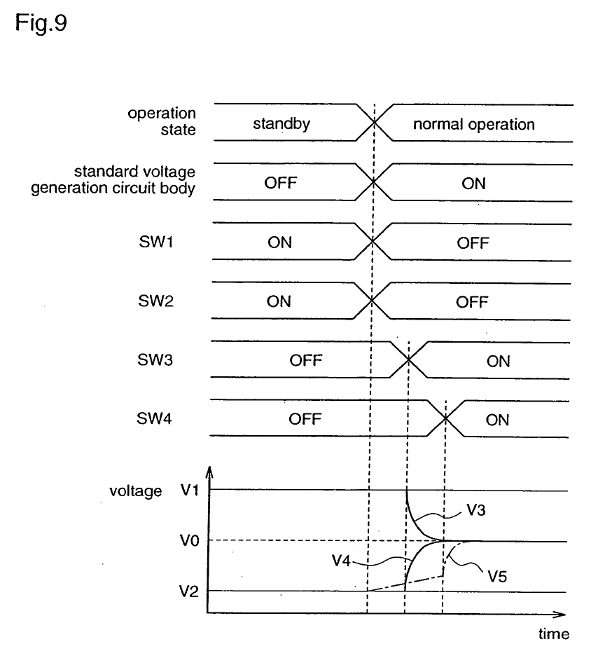

FIG. 9 is a diagram illustrating the operation state of the standard voltage generation circuit body 10 according to the fourth embodiment, the timings of ON/OFF state changes of the switches SW1 to SW4, and the voltage changes at the respective points of the standard voltage generation circuit.

During the standby period, the standard voltage generation circuit body 10 is in its OFF state, and therefore, does not consume power. At this time, the output voltage V5 at the output terminal 9 is the ground voltage V2. Further, the switch SW1 and the switch SW2 are in their ON states, the switch SW3 and the switch SW4 are in their OFF states, and the first capacitor element C1 and the second capacitor element C2 are set at the voltage V1 and the voltage V2, respectively.

During transition from the standby period to the normal operation period, the switch SW1 and the switch SW2 are initially turned off to hold the reset state. Further, at this time, the standard voltage generation circuit body 10 is turned on, and the output voltage V5 at the output terminal 9 approaches the standard voltage V0.

When the switch SW3 changes from the OFF state to the ON state, the third voltage V3 at an end of the first capacitor element C1 and the fourth voltage V4 at an end of the second capacitor element C2 converge to a voltage in the vicinity of the standard voltage V0, according to the capacitance ratio between the capacitor element C1 and the capacitor element C2.

Next, when the switch SW4 changes from the OFF state to the ON state, the output terminal 9 becomes electrically continuous with the first and second capacitor elements C1 and C2 that have the voltage values in the vicinity of the standard voltage V0, and thereby the voltage at the output terminal 9 rapidly increases toward the standard voltage V0.

As described above, the standard voltage generation circuit according to the fourth embodiment is provided with the standard voltage generation circuit body 10; the first capacitor element C1 and the second capacitor element C2 which are respectively connected to voltages higher and lower than the standard voltage, and are charged during the standby period; and the switch SW4 which connects the node of the capacitor elements C1 and C2 to the output terminal of the standard voltage generation circuit body 10 during the normal operation. Therefore, the capacitor elements C1 and C2 having the selected capacitance values are charged to a predetermined voltage during the standby period so that the voltage at the node of the capacitor elements C1 and C2 is close to the standard voltage V0, and the node of the capacitor elements C1 and C2 is connected to the output terminal 9 during the normal operation period, whereby the standard voltage generation circuit can move, in a short time, to the operation state where the standard voltage V0 is generated.

### Fifth Embodiment

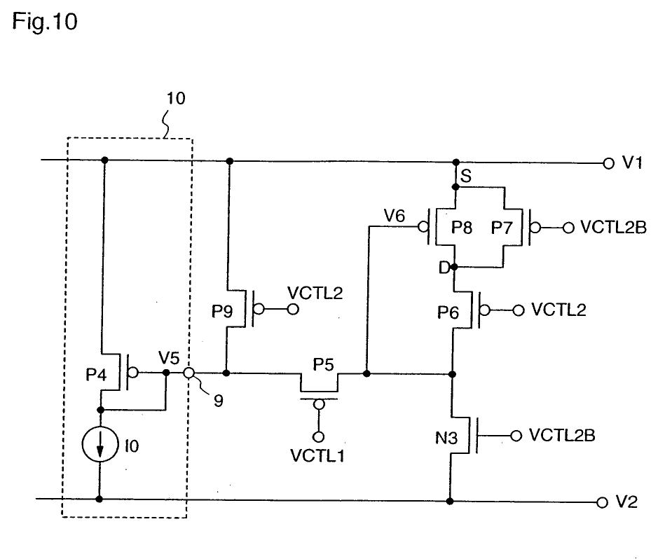

FIG. 10 is a block diagram illustrating the construction of a standard voltage generation circuit according to a fifth embodiment of the present invention.

In FIG. 10, the standard voltage generation circuit is provided with a standard voltage generation circuit body 10; a PMOS transistor P8 as a first conductivity type eighth transistor; first conductivity type fifth to seventh transistors P5 to P7; a second conductivity type third transistor N3; and a first conductivity type ninth transistor P9. These transistors P5 to P7, N3, and N9 function as switches.

The standard voltage generation circuit body 10 is constituted by a current source I0 having an end connected to a ground voltage V2; and a PMOS transistor P4 having a source connected to a power supply voltage V1, and a gate and a drain connected to each other. The standard voltage generation circuit body 10 generates a standard voltage V0 from an output terminal 9 that is a node between the current source I0 as a constant current source and the PMOS transistor P4 as a first conductivity type transistor.

The PMOS transistors P6 and P7 are inserted between the gate and the drain of the PMOS transistor P8 and between the source and the drain of the PMOS transistor P8, respectively, and the source of the PMOS transistor P8 is connected to the power supply voltage V1.

The gate of the PMOS transistor P8 and the drain of the NMOS transistor N3, whose source is connected to the ground voltage V2, are connected to the output terminal 9 through the PMOS transistor P5. Further, the drain of the PMOS transistor P9, whose source is connected to the power supply voltage V1, is connected to the output terminal 9.

Furthermore, the gate of the PMOS transistor P5 is connected to a control voltage VCTL1, and the gates of the PMOS transistors P6 and P9 are connected to a control voltage VCTL2. The gate of the PMOS transistor P7 and the gate of the NMOS transistor N3 are connected to a control voltage VCTL2B whose phase is complementary to the phase of the control voltage VCTL2. The transistors P5 to P7, N3, and P9 function as switch elements whose ON/OFF operations are controlled by the control voltages VCTL1, VCTL2, and VCTL2B.

Further, the substrates of all PMOS transistors are connected to the power supply voltage V1, and the substrate of the NMOS transistor is connected to the ground voltage V2.

Hereinafter, the operation of the standard voltage generation circuit according to the fifth embodiment constituted as described above will be described.

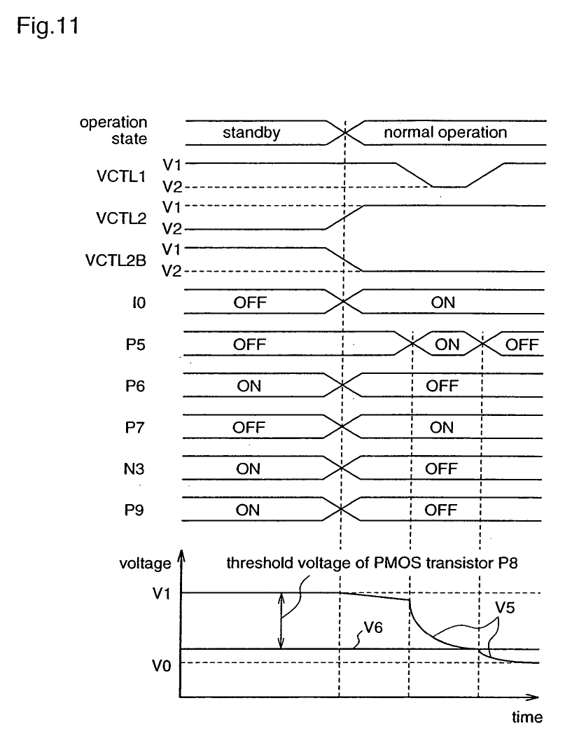

FIG. 11 is a diagram illustrating the operation state of the standard voltage generation circuit body 10, the timings of ON/OFF state changes of the transistors P5 to P7, N3, and P9, and the voltage change of the standard voltage generation circuit.

During the standby period, the control voltage VCTL2 is the ground voltage V2, and the control voltages VCTL1 and VCTL2B are the power supply voltage V1. The current source I0 is in the OFF state, and the standard voltage generation circuit body 10 does not consume current. Since the PMOS transistor P5 is in the OFF state and the PMOS transistor P9 is in the ON state, the output voltage V5 at the output terminal 9 is the power supply voltage V1.

Further, since the PMOS transistor P6 is in the ON state and the PMOS transistor P7 is in the OFF state, the PMOS transistor P8 is in the so-called diode connection state wherein the gate and the drain are electrically connected. Since the NMOS transistor N3, whose transistor size is predetermined so that the gate-to-source voltage of the PMOS transistor P8 approaches the threshold voltage, is in the ON state, the gate voltage V6 of the PMOS transistor P8 becomes a voltage that is lower than the power supply voltage V1 by the threshold voltage.

When the standard voltage generation circuit body 10 changes from the standby state to the normal operation state, initially the control voltage VCTL2 becomes the power supply voltage V1, and the control voltage VCTL2B becomes the ground voltage V2. The current source I0 changes to the ON state, and the PMOS transistor P9 changes to the OFF state, whereby the output voltage V5 at the output terminal 9 drops toward the standard voltage V0.

At the same time, the PMOS transistor P6 changes to the OFF state, and the PMOS transistor P7 changes to the ON state, whereby the source and the drain of the PMOS transistor P8 are electrically connected to the power supply voltage V1. Further, since the NMOS transistor N3 changes to the OFF state, the PMOS transistor P8 functions as a capacitor element, and stores, as the gate voltage V6, a voltage that is lower than the power supply voltage V1 by the threshold voltage, in comparison with the source, drain, and substrate which are electrically connected to the power supply voltage V1.

When the PMOS transistor P5 changes to the ON state, the source and drain of the PMOS transistor P5 are brought into conduction, and the output voltage V5 and the gate voltage V6 change to be the same voltage.

The gate voltage V6 is a charging voltage for the PMOS transistor P8 that functions as a capacitor element, and the gate area of the PMOS transistor P8 is set at a size that is sufficiently larger than that of the PMOS transistor P4. Therefore, the voltage change of the gate voltage V6 is smaller than the output voltage V5, and the output voltage V5 dramatically changes to a voltage in the vicinity of the gate voltage V6, that is, a voltage which is lower than the power supply voltage V1 by the threshold voltage of the PMOS transistor P8. The PMOS transistor P5 changes to the OFF state after a predetermined period during which the voltage change of the output voltage V5 becomes the steady state, and the output voltage V5 drops toward the standard voltage V0 by the current source I0.

The voltage response of the output voltage V5 during the period in which the PMOS transistor changes to the ON state is determined by the ON resistance of the PMOS transistor P5 and the capacitance value connected to the output terminal 9. In the current semiconductor process (0.35 μm−0.13 μm process), the ON resistance is about 100Ω, the capacitance value is about 1 pF in general design, and the time constant is about 0.1 ns. Therefore, about 1 ns can be easily realized as a voltage response time of the output voltage V5 to the steady state. On the other hand, as for the current value of the current source I0, since it is about 10 μA in general design, when the threshold voltage of the PMOS transistor P8 is 0.5 V, the voltage response time to the normal state is at least about 50 ns. Therefore, in this fifth embodiment, the speed of the voltage change of the output voltage V5 to the standard voltage V0 can be enhanced as compared with the case where only the current source I0 is used.

As described above, the standard voltage generation circuit according to the fifth embodiment is provided with the standard voltage generation circuit body 10 comprising the P type transistors and the constant current source; the P type transistor P8 having a gate voltage that is biased to the high power supply voltage in the vicinity of the standard voltage during the standby period, and functioning as a capacitor during the normal operation period; and the P type transistor P5 that connects, as a switch, the transistor P8 and the output terminal of the standard voltage generation circuit body 10. Therefore, as compared with the case whereby only the ordinary standard voltage generation circuit body 10 is used, the output voltage V5 of the standard voltage generation circuit can be rapidly changed to the standard voltage V0.

### Sixth Embodiment

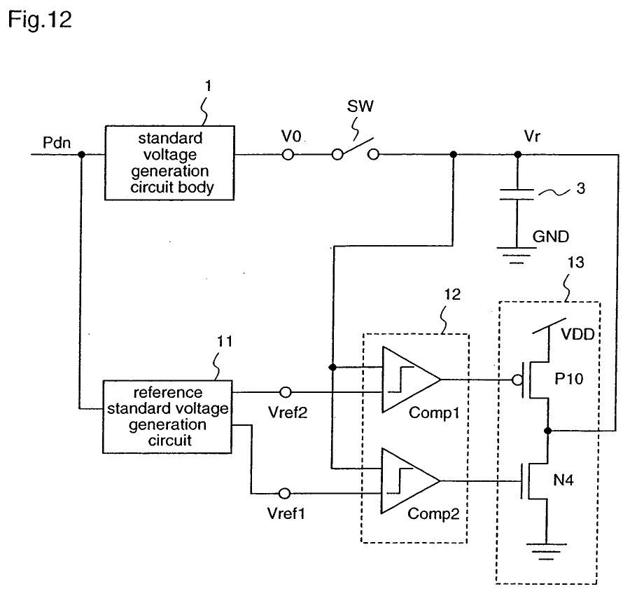

FIG. 12 is a block diagram illustrating the construction of a standard voltage generation circuit according to a sixth embodiment of the present invention.

In FIG. 12, the standard voltage generation circuit is provided with a standard voltage generation circuit body 1 for generating a standard voltage; a standard voltage stabilization capacitor 3 for stabilizing the standard voltage; a switch SW for connecting an output terminal of the standard voltage generation circuit body 1 and the standard voltage stabilization capacitor 3, which switch SW is turned off during a first period in which the standard voltage is not used, and is turned on during a second period in which the standard voltage is used; a reference standard voltage generation circuit 11 for generating two reference voltages Vref1 and Vref2; a voltage detection circuit 12 for detecting and comparing a voltage at an end of the standard voltage stabilization capacitor 3 and the reference voltage, and outputting the result; and a control circuit 13 for controlling charging/discharging of the capacitor 3 according to the result of detection by the voltage detection circuit 12.

The voltage detection circuit 12 is provided with two comparators Comp1 and Comp2, compares the voltage at an end of the standard voltage stabilization capacitor 3 with the two reference voltages, and outputs a signal indicating one of the following three states: the voltage at the end of the standard voltage stabilization capacitor 3 is higher than the first reference voltage, it is lower than the second reference voltage, and it is between the first reference voltage and the second reference voltage. The control circuit 13 is constituted by a P type transistor P10 as a first conductivity type transistor, and an N type transistor N4 as a second conductivity type transistor, and the control circuit 13 controls charging/discharging of the capacitor 3 according to the output of the voltage detection circuit 12.

The output of the standard voltage generation circuit body 1 is connected, through the switch SW, to an end of the standard voltage stabilization capacitor 3 (the other end of the standard voltage stabilization capacitor 3 is connected to a standard voltage (GND) as a fifth fixed voltage), to the drain terminal of the transistor P10 and the drain terminal of the transistor N4 in the control circuit 13, and to the input terminals of the comparators Comp1 and Comp2 of the voltage detection circuit 12.

A source terminal of the transistor P10 is connected to a standard voltage (VDD), a source terminal of the transistor N4 is connected to the standard voltage (GND), a gate terminal of the transistor P10 is connected to an output terminal of the comparator Comp1, a gate terminal of the transistor N4 is connected to an output terminal of the comparator Comp2, an output terminal Vref2 of the reference standard voltage generation circuit 11 is connected to a comparison voltage terminal of the comparator Comp1, an output terminal Vref1 of the reference standard voltage generation circuit 11 is connected to a comparison voltage terminal of the comparator Comp2, and a standby terminal is connected to an input terminal of the standard voltage generation circuit body 1 and to an input terminal of the reference standard voltage generation circuit 11. It is assumed that Vref1>Vref2.

The operation of the standard voltage generation circuit constituted as described above will now be described.

In this sixth embodiment, a description will be given of only the operation in the case where the voltage Vr at an end of the standard voltage stabilization capacitor 3 becomes lower than the reference voltage Vref 2.

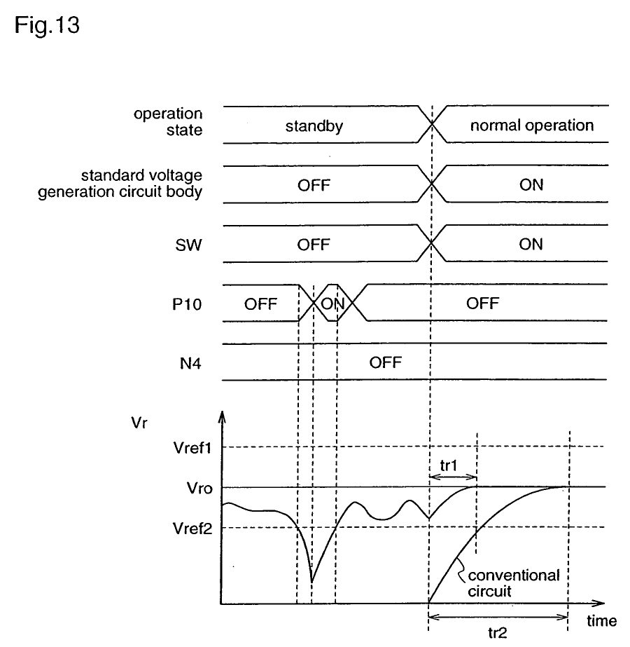

FIG. 13 is a diagram illustrating changes in the output voltage of the standard voltage generation circuit according to the sixth embodiment and in the output voltage of the conventional standard voltage generation circuit.

At standby, the switch SW is in the OFF state. When the voltage Vr is equal to or lower than the reference voltage Vref1 and equal to or higher than the reference voltage Vref2, both of the transistor P10 and the transistor N4 are in their OFF states. When the voltage Vr becomes lower than the reference voltage Vref2 due to influences such as the passage of time and noise, only the transistor P10 is turned on. Accordingly, current flows into the standard voltage stabilization capacitor 3 from the standard voltage (VDD) through the transistor P10, and thereby the voltage Vr increases. When the voltage Vr becomes equal to or higher than the reference voltage Vref2, the transistor P10 is again turned off and the current flow into the standard voltage stabilization capacitor 3 is stopped, whereby the value of the voltage Vr is maintained.

When the voltage Vr becomes equal to or higher than the reference voltage Vref1, the transistor N4 is turned on and current flows from the standard voltage stabilization capacitor 3, and thereby the voltage Vr drops.

Further, when the standard voltage generation circuit changes to the normal operation state, the switch SW is turned on, and the output terminal of the standard voltage generation circuit body 1 is connected to the standard voltage stabilization capacitor 3 through the switch SW, and the voltage V0 at the output terminal rapidly approaches the voltage Vr and finally reaches the stable standard voltage Vr0.

As described above, the standard voltage generation circuit according to the sixth embodiment is provided with the standard voltage generation circuit body 1, the reference standard voltage generation circuit 11 for generating two reference voltages, the standard voltage stabilization capacitor 3, the voltage detection circuit 12 for comparing the voltage at an end of the capacitor 3 and the reference voltages, the control circuit 13 for controlling charging/discharging of the capacitor 3, and the switch SW for connecting the standard voltage generation circuit body 1 and the capacitor 3. Therefore, during the standby period, the standard voltage generation circuit tries to maintain the voltage Vr at an end of the capacitor 3, at a voltage between the reference voltage Vref1 and the reference voltage Vref2. When the standard voltage generation circuit recovers to the normal operation, the output terminal of the standard voltage generation circuit body 1 is connected to an end of the capacitor 3 wherein the voltage Vr is in the vicinity of the stable standard voltage Vr0, whereby the time tr1 that is required until the voltage Vo at the output end of the standard voltage generation circuit body 1 reaches the stable standard voltage Vr0 can be reduced as compared with the conventional circuit.

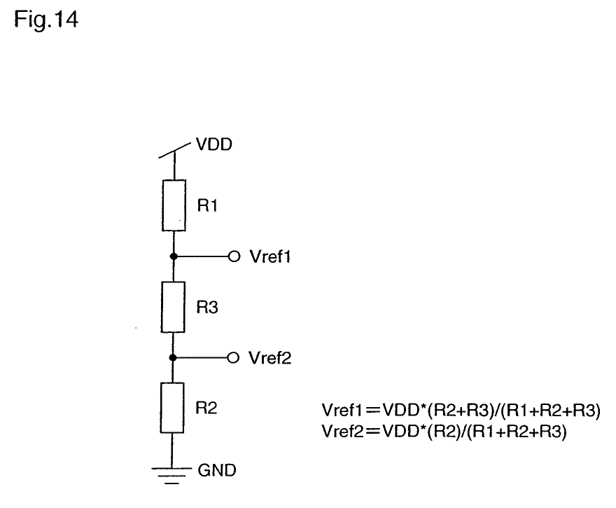

The reference standard voltage generation circuit 11 can be implemented by resistance type potential division as shown in FIG. 14.

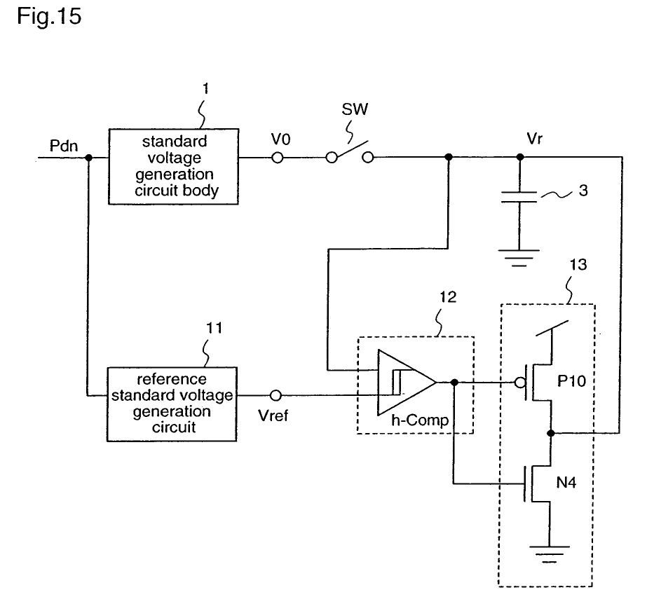

Further, FIG. 15 is a block diagram illustrating the construction of a standard voltage generation circuit using a hysteresis comparator h-Comp as a voltage detection circuit 12.

With reference to FIG. 15, an output terminal of a reference standard voltage generation circuit 11 for generating one reference voltage may be connected to a standard voltage terminal of the hysteresis comparator, and an output terminal of the hysteresis comparator may be connected to gate terminals of the first conductivity type transistor P10 and the second conductivity type transistor N4, with the same effects as described above.

### Seventh Embodiment

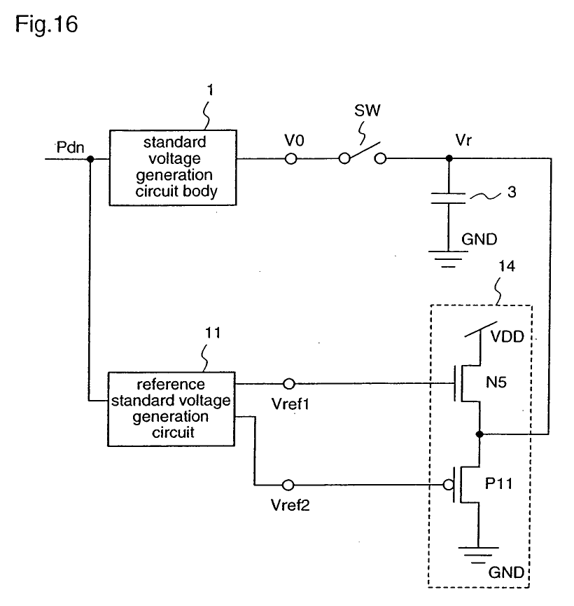

FIG. 16 is a block diagram illustrating the construction of a standard voltage generation circuit according to a seventh embodiment of the present invention.

In FIG. 16, the standard voltage generation circuit is provided with a standard voltage generation circuit body 1 for generating a standard voltage; a standard voltage stabilization capacitor 3 for stabilizing the standard voltage; a reference standard voltage generation circuit 11 for generating two reference voltages Vref1 and Verf2 at high and low potentials, respectively, from the standard voltage; a switch SW for connecting the standard voltage stabilization capacitor 3 to an output terminal of the standard voltage generation circuit body 1; and a voltage detection control circuit 14 for comparing a voltage at a node between the switch SW and the standard voltage stabilization capacitor 3 with the reference voltages, and controlling charging/discharging of the standard voltage stabilization capacitor 3. The voltage detection control circuit 14 comprises an N type transistor N5 as a second conductivity type transistor, and a P type transistor P11 as a first conductivity type transistor.

Further, the output of the standard voltage generation circuit body 1 is connected to, through the switch SW, an end of the standard voltage stabilization capacitor 3 (the other end of the standard voltage stabilization capacitor 3 is connected to a standard voltage (GND)), a source terminal of the transistor N5 of the voltage detection control circuit 14, and a source terminal of the transistor P11. A drain terminal of the transistor N5 is connected to a standard voltage (VDD), a drain terminal of the transistor P11 is connected to a standard voltage (GND), a gate terminal of the transistor N5 is connected to an output terminal Vref1 of the reference standard voltage generation circuit 11, a gate terminal of the transistor P11 is connected to an output terminal Vref2 of the reference standard voltage generation circuit 11, and a standby terminal Pdn is connected to an input terminal of the standard voltage generation circuit body 1 and to an input terminal of the reference standard voltage generation circuit 11.

It is assumed that the reference voltages Vref1 and Vref2 are expressed by
Vref1=Vro+Vthn
Vref2=Vro−|Vthp|
wherein Vro is the stable standard voltage value, Vthn is the threshold value of the n type transistor N5, and Vthp is the threshold voltage of the P type transistor P11.

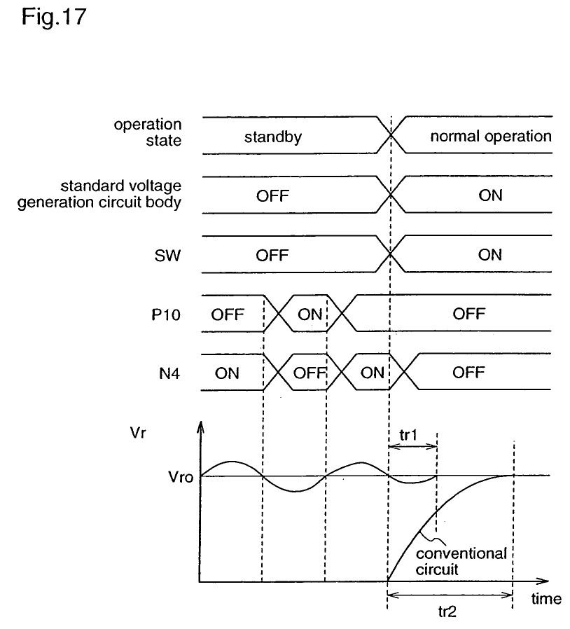

The operation of the reference voltage generation circuit constituted as described above will now be described with reference to FIG. 17.

In this seventh embodiment, a description will be given of only the case where the voltage Vr at an end of the standard voltage stabilization capacitor 3 becomes equal to or lower than the stable reference voltage Vr0.

FIG. 17 is a diagram illustrating an output voltage of the reference voltage generation circuit according to the seventh embodiment, and an output voltage of the conventional reference voltage generation circuit.

At standby, the switch SW is in its OFF state. When Vr=Vro, the gate-to-source voltages Vgs of the transistors N5 and P11 are equal to the threshold value Vth, and therefore, only a minute current flows in the two transistors N5 and P11. When the voltage Vr becomes equal to or lower than the stable standard voltage Vro, the transistor N5 is turned on, and the transistor P11 is completely turned off. Then, current flows into the standard voltage stabilization capacitor 3 from the transistor N5, and thereby the voltage Vr increases.

When the voltage Vr becomes equal to or higher than the stable standard voltage Vro, the transistor P11 is turned on and the transistor N5 is turned off, and current flows into the transistor P11 from the standard voltage stabilization capacitor 3, whereby the voltage Vr drops.

Further, when the standard voltage generation circuit changes to the normal operation state, the switch SW is turned on, and the output terminal of the standard voltage generation circuit body 1 is connected through the switch SW to the standard voltage stabilization capacitor 3, and the voltage V0 at the output terminal rapidly approaches the voltage Vr and finally reaches the stable standard voltage Vr0.

As described above, the standard voltage generation circuit according to the seventh embodiment is provided with, in addition to the standard voltage generation circuit body 1, the reference standard voltage generation circuit 11 for generating reference voltages, the standard voltage stabilization capacitor 3 for stabilizing the reference voltages, the switch SW that is turned off during the standby period and turned on during the normal operation period, and the voltage detection control circuit 14 for comparing the voltage at an end of the capacitor 3 and the reference voltages and controlling charging/discharging of the standard voltage stabilization capacitor 3 according to the comparison result. Therefore, the standard voltage generation circuit continuously maintains the voltage Vr at an end of the standard voltage stabilization capacitor 3 in the vicinity of the standard voltage Vro during the standby period. When the standard voltage generation circuit recovers to the normal operation, the standard voltage generation circuit connects the output terminal of the standard voltage generation circuit body 1 to the end of the standard voltage stabilization capacitor 3 where the voltage Vr is in the vicinity of the stable standard voltage Vr0, whereby the time tr1 that is required until the voltage Vo at the output terminal of the standard voltage generation circuit body 1 reaches the stable standard voltage Vro can be reduced as compared with the conventional circuit.

By applying a voltage Vro<Vref1<Vro+Vthn and a voltage Vro<Vref2<Vro−|Vthp| to the Vref1 and the Vref2 in the circuit shown in FIG. 16, respectively, a dead zone where both of the transistors N5 and P11 are turned off can be created as shown in FIG. 12. The width of the dead zone is, with the Vro in the center, Vro+Vthn−Vref1 in the plus direction and Vref2−Vro+|Vthp| in the minus direction.

Further, while the reference standard voltage generation circuit 11 can be implemented by the circuit shown in FIG. 14, an eighth embodiment of the invention described below shows an example of a reference standard voltage generation circuit that generates more stable reference voltages against variations in processing.

### Eighth Embodiment

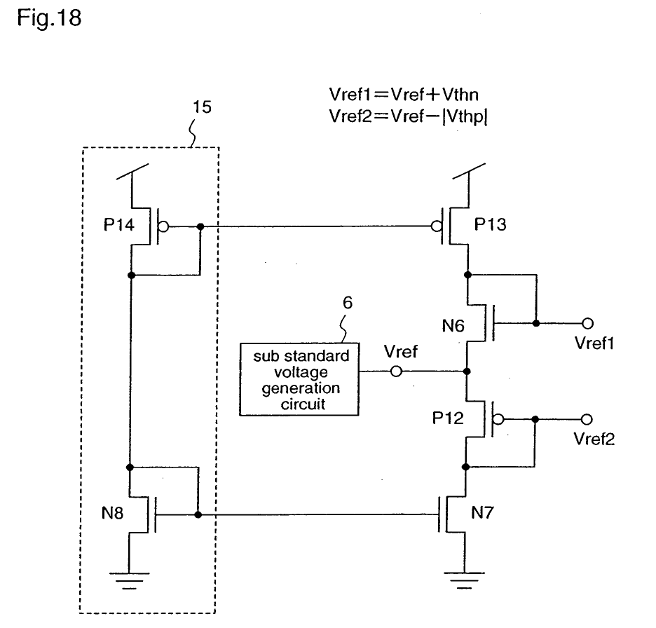

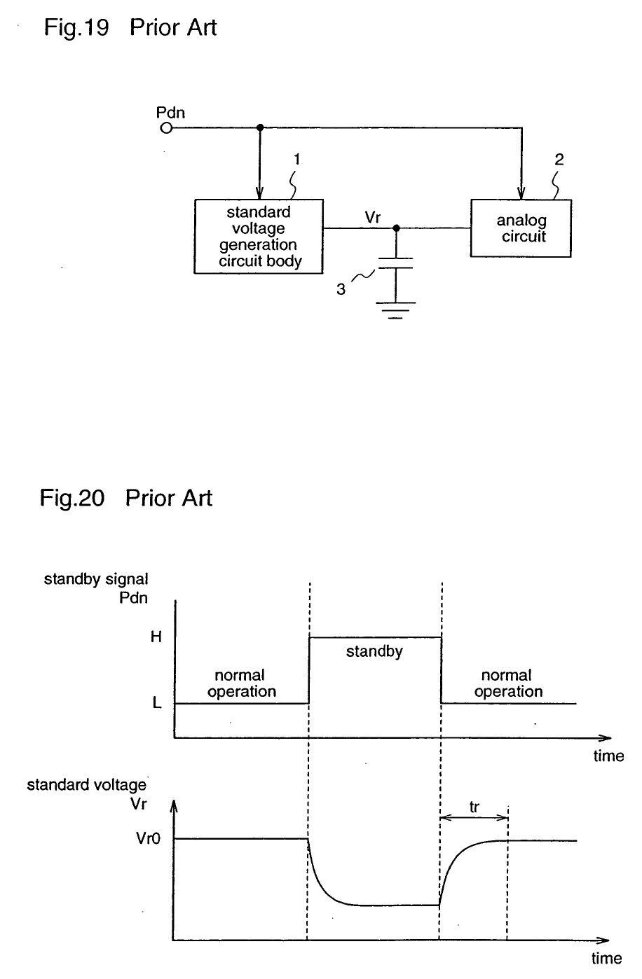

FIG. 18 is a block diagram illustrating the construction of a reference standard voltage generation circuit which is included in a standard voltage generation circuit according to an eighth embodiment of the present invention.

The construction of the standard voltage generation circuit according to the eighth embodiment is identical to that described for the seventh embodiment.

In FIG. 18, the reference standard voltage generation circuit is constituted by a bias circuit 15 comprising a P type transistor P14 as a first conductivity type fourteenth transistor and an N type transistor N8 as a second conductivity type eighth transistor, a sub standard voltage generation circuit 6 for generating a reference voltage Vref, P type transistors P12 and P13 as first conductivity type twelfth and thirteenth transistors, and N type transistors N6 and N7 as second conductivity type sixth and seventh transistors.

A gate terminal of the transistor P14 of the bias circuit 15 is connected to a drain terminal of the transistor P14, to a gate terminal of the current mirror P type transistor P13, to a gate terminal and a drain terminal of the transistor N8 of the bias circuit 15, and to a gate terminal of the current mirror N type transistor N7.

A source terminal of the transistor P14 is connected to the standard voltage (VDD), a source terminal of the transistor N8 is connected to the standard voltage (GND), a source terminal of the transistor P13 is connected to the standard voltage (VDD), a source terminal of the transistor N7 is connected to the standard voltage (GND), an output terminal of the sub standard voltage generation circuit 6 is connected to a source terminal of the transistor N6 and to a source terminal of the transistor P12, a drain terminal of the transistor P13 is connected to a gate terminal and a drain terminal of the transistor N6, and a drain terminal of the transistor N7 is connected to a gate terminal and a drain terminal of the transistor P12. Further, a gate terminal of the transistor N6 and a gate terminal of the transistor P12 are connected to the output terminals Vref1 and Vref2 of the reference standard voltage generation circuit, respectively.

The operation of the reference standard voltage generation circuit constituted as described above will now be described.

The bias circuit 15 is sized so that a minute current flows into the transistor. By the current mirror structure, minute current also flows into the respective transistors P13, N7, P12, and N6, and a voltage that is approximately equal to the threshold voltage is generated as the gate-to-source voltages Vgs of the transistors N6 and P12. Since the source terminal voltages of the transistors N6 and P12 are fixed to the sub standard voltage Vref generated by the sub standard voltage generation circuit 6, the reference voltages Vref1 and Vref2 become Verf1=Vref+Vthn and Vref2=Vref−|Vthp|, respectively.

As described above, the reference standard voltage generation circuit according to the eighth embodiment is provided with the bias circuit 15 comprising the P type transistor P14 and the N type transistor N8, the sub standard voltage generation circuit 6 for generating a reference voltage, the transistors P13 and N7 that function as a current mirror in conjunction with the transistors of the bias circuit 15, and the transistors P12 and N6 for generating desired reference voltages. Therefore, stable reference voltages with less variation can be obtained.

As described above, since the standard voltage generation circuit according to the present invention can rapidly generate a stable standard voltage, the standard voltage generation circuit of the present invention is suitable for a standard voltage source of a device in which a transition time required from the standby state to normal operation state should be reduced.

What is claimed is:

1. A standard voltage generation circuit comprising:
a standard voltage generation circuit body for generating a standard voltage;
a standard voltage stabilization capacitor for stabilizing the standard voltage;
a standard voltage rapid stabilizer for rapidly stabilizing the standard voltage;
a sub standard voltage generation circuit for generating a sub standard voltage;
a voltage detection comparator for comparing the standard voltage generated by said standard voltage generation circuit body with the sub standard voltage generated by said sub standard voltage generation circuit, and outputting the result of the comparison; and
a stop circuit for stopping the operation of said standard voltage rapid stabilizer for charging or discharging said standard voltage stabilization capacitor, according to the result of the comparison by said voltage detection comparator.

2. A standard voltage generation circuit as defined in claim 1, wherein said sub standard voltage generation circuit is not provided with a capacitor for stabilizing the sub standard voltage.

3. A standard voltage generation circuit as defined in claim 1, wherein said sub standard voltage generation circuit comprises a resistance type potential divider.
